(19) United States
(12) Patent Application Publication
(10) Pub. No.: US 2024/0316562 A1
(43) Pub. Date: Sep. 26, 2024

(54) CARTRIDGE SYSTEM FOR EXTRACTING COLLECTED SAMPLE, AND METHOD FOR EXTRACTING COLLECTED SAMPLE

(71) Applicant: MICRO DIGITAL CO., LTD, Seongnam-si, Gyeonggi-do (KR)

(72) Inventors: Kyung Nam KIM, Gwangju-si, Gyeonggi-do (KR); Se Hak LIM, Gunpo-si, Gyeonggi-do (KR); Jong In RYU, Yongin-si, Gyeonggi-do (KR)

(21) Appl. No.: 18/579,175

(22) PCT Filed: Jul. 1, 2022
(86) PCT No.: PCT/KR2022/009504

§ 371 Date: Jan. 12, 2024

(30) Foreign Application Priority Data
Jul. 13, 2021 (KR) 10-2021-0091522

(51) Int. Cl. B01L 3/00; G01N 35/00; G01N 35/10

(52) U.S. Cl. CPC B01L 3/508; G01N 35/0099; G01N 35/10; B01L 2200/02; B01L 2200/0689; B01L 2300/0681; B01L 2400/0409; G01N 2035/1058

(57) ABSTRACT

Provided is a cartridge system for extracting a collected sample. The cartridge system may include: a cartridge body; a dewatering tip-receiving unit in which a dewatering tip is received such that a collecting member to which a sample is collected can be received; a spin cover-receiving unit in which a spin cover is received such that a spin head of a robot device can be equipped with the spin cover; a buffer chamber unit in which a buffer solution is received such that the sample from the collecting member through dewatering by the rotation of the spin head can be received in the buffer solution; and a dispensing tip-receiving unit in which a dispensing tip is received such that a pump head of the robot device can be equipped with the dispensing tip to suction the buffer solution including the sample.

### TECHNICAL FIELD

The present invention relates to a cartridge system for extracting a collected sample and a method for extracting a collected sample, and more specifically, to a cartridge system for extracting a collected sample and a method for extracting a collected sample, which allow a DNA or RNA sample collected through a cotton swab or other collection units to be analyzed rapidly and accurately through an automated series of processes.

### BACKGROUND ART

Molecular diagnosis refers to a diagnostic method that directly analyzes the genes (DNA or RNA) of a target substance in a sample to identify the presence of infection of disease, base sequence variations, or mutations, enabling early disease diagnosis and efficient treatment.

Recently, molecular diagnostic methods have been widely used in various medical fields, including confirmation of disease infection, genetic testing, and pharmacogenetic testing.

Various detection methods have been developed for the molecular diagnostic methods, with real-time polymerase chain reaction (PCR) becoming widely used due to its speed, convenience, and sensitivity in detection. Real-time PCR typically uses a probe that forms a specific complementary binding with the gene of a target substance, and fluorescence molecules are attached to the probe. In real-time PCR, the wavelength of these fluorescence molecules is analyzed by an analyzing device to qualitatively/quantitatively analyze the target gene.

On the other hand, in the molecular diagnostic methods, through real-time PCR, the target substance collected on a swab or a collection part is subjected to pretreatment before analysis, and the pretreated substance, i.e., a buffer solution, is analyzed. According to conventional techniques, due to each component for performing various processes required in the molecular diagnosis processes the size of molecular diagnostic equipment has been large, and the structure has become complex. Also, significant costs and time have been wasted in the preprocessing process, and automating this series of processes has been challenging.

### DETAILED DESCRIPTION OF THE INVENTION

### Technical Problem

The present invention is to provide a cartridge system for extracting a collected sample and a method for extracting a collected sample, wherein a series of processes for extracting a collected sample from a cotton swab or a collection unit into a buffer solution in a cartridge format for the application of a molecular diagnostic method is automated and integrated, thereby enhancing the efficiency of sample extraction, the time and cost involved in sample extraction can be significantly reduced, precise, uniform, and highly reliable sample pretreatment processes may be conducted regardless of the operator's skill level or working environment, sample contamination or leakage during the process may be fundamentally prevented, the application to an on-site rapid diagnostic kit is possible, enabling quick achievement of test results within minutes or hours on-site, and after completing the preprocessing process, all components can be disposed of or incinerated together, ensuring a highly hygienic process. However, the above object is illustrative only, and does not limit the scope of the present invention.

### Technical Solution

According to an aspect of the present invention, there is provided a cartridge system for extracting a collected sample, including a cartridge body; a dewatering tip-receiving unit formed in the cartridge body and configured to accommodate a dewatering tip such that a collecting member that has collected a sample is accommodated; a spin cover-receiving unit formed in the cartridge body and configured to accommodate a spin cover of a robot device such that the spin head can be equipped with the spin cover; a buffer chamber unit formed in the cartridge body and configured to accommodate a buffer solution such that a sample from the collecting member can be discharged and received in the buffer solution through dewatering by the rotation of the spin head of the robot device when the collecting member is immersed into the buffer solution while the spin head equipped with the spin cover is coupled with the dewatering tip; and a dispensing tip-receiving unit formed in the cartridge body and configured to accommodate a dispensing tip such that a pump head of the robot device can be equipped with the dispensing tip to aspirate the buffer solution containing the sample.

In addition, according to the present invention, the dewatering tip may include a dewatering tip body in which a collected sample-receiving area is formed to accommodate a portion of the collecting member; a segmentation groove portion formed at the entrance of the dewatering tip body to allow bending and segmentation of a portion of the collecting member; a middle constricted portion formed at the bottom of the dewatering tip body to allow the collecting member to be temporarily fitted and fixed in the middle; and a dewatering slot portion formed at the bottom of the middle constricted portion to allow the buffer solution, containing the sample, to be dewatered and extracted from the collecting member by the centrifugal force when rotated using the spin head after the collecting member is fully inserted.

Additionally, according to the present invention, the spin cover may include a spin cover body with a head coupling portion formed to be coupled with the spin head; and a pressing edge portion that, when inserted into the entrance of the dewatering tip body during coupling with the dewatering tip, pressurizes the collecting member to enable the complete insertion of the collecting member, which is temporarily fixed in the middle constricted portion, into the dewatering slot portion.

Moreover, according to the present invention, the buffer chamber unit may include a buffer solution-receiving portion formed with a first diameter to accommodate the buffer solution so that the collecting member can be sufficiently immersed below the level of the buffer solution; a dewatering portion formed with a second diameter larger than the first diameter to allow the collecting member to rise sufficiently above the level of the buffer solution for rotation and dewatering; and a guiding slope portion having a guiding slope surface continuously changing in diameter from the first diameter to the second diameter to guide the dewatered buffer solution in the direction of the buffer solution-receiving portion.

Additionally, according to the present invention, the cartridge system may further include a filter tip-receiving unit formed in the cartridge body and configured to accommodate a filter tip such that when the dispensing tip that has aspirated the buffer solution containing the sample dispenses the buffer solution to the filter tip, the spin head can be coupled with the filter tip and rotate it to stir the buffer solution.

In addition, according to the present invention, the filter tip may include a filter tip body, which has an inlet portion formed on an upper side thereof into which a front end of the dispensing tip is inserted, an accommodating portion in which the buffer solution is accommodated, and an outlet portion from which the buffer solution is discharged; a plurality of beads installed in the accommodating portion to facilitate agitation of the buffer solution; and a mesh filter installed between the accommodating portion and the outlet portion.

Additionally, according to the present invention, the filter tip may further include a temporary sealing member that temporarily seals the outlet portion.

Also, according to the present invention, the cartridge system may further include a cutting edge unit formed in the cartridge body and sharply shaped to facilitate breaking or removal of the temporary sealing member.

In addition, according to the present invention, the cartridge system may further include a collecting tube-receiving unit formed in the cartridge body and configured to accommodate a final solution collecting tube such that the pump head coupled with the filter tip can inject the buffer solution containing the sample into the final solution collecting tube.

According to another aspect of the present invention, there is provided a method for extracting a collected sample, including the steps of: (a) accommodating a collecting member that has collected a sample in a dewatering tip-receiving unit of a cartridge body; (b) mounting a spin cover to a spin head of a robot device; and (c) immersing the collecting member into a buffer solution in a buffer chamber unit by coupling a dewatering tip with the spin head of the robot device with the spin cover mounted thereto, followed by accommodating the sample in the buffer solution within the buffer chamber unit through dewatering by the rotation of the spin head.

In addition, according to the present invention, the step (a) may include: (a-1) inserting a portion of the collecting member into the dewatering tip accommodated in the dewatering tip-receiving unit; and (a-2) temporarily fit and fix the collecting member to a middle constricted portion of the dewatering tip by bending and segmenting a portion of the collecting member.

Additionally, according to the present invention, the step (c) may include: (c-1) fully inserting the collecting member into a dewatering slot portion of the dewatering tip by pressurizing the collecting member using a pressing front end portion of the spin head; (c-2) immersing the collecting member below the level of the buffer solution in the buffer chamber unit; and (c-3) raising the collecting member above the level of the buffer solution in the buffer chamber unit and rotating and dewatering the sample to be accommodated in the buffer solution.

In addition, according to the present invention, the method may further include the steps of: (d) aspirating the buffer solution containing the sample using a pump head of the robot device equipped with a dispensing tip; (e) when the dispensing tip dispenses the buffer solution containing the sample to a filter tip, stirring the buffer solution while rotating the filter tip using the spin head coupled with the filter tip; and (f) injecting the buffer solution containing the sample into a final solution collecting tube.

Additionally, according to the present invention, the step (f) may include: (f-1) breaking or removing a temporary sealing member temporarily sealed to an outlet portion of the filter tip using a cutting edge unit; and (f-2) injecting the buffer solution into the final solution collecting tube when the pump head is coupled with the filter tip and the temporary sealing member is broken or removed.

### Effect of the Invention

According to some embodiments of the present invention as described above, a series of processes for extracting a collected sample from a cotton swab or a collection unit into a buffer solution in a cartridge format for the application of a molecular diagnostic method can be automated and integrated, thereby enhancing the efficiency of sample extraction, the time and cost involved in sample extraction can be significantly reduced. Also, precise, uniform, and highly reliable sample pretreatment processes can be conducted regardless of the operator's skill level or working environment, sample contamination or leakage during the process can be fundamentally prevented, the application to an on-site rapid diagnostic kit is possible, enabling quick achievement of test results within minutes or hours on-site, and after completing the preprocessing process, all components can be disposed of or incinerated together, ensuring a highly hygienic process. However, the above effects do not limit the scope of the present invention.

### BRIEF DESCRIPTION OF DRAWINGS

FIG. 1 is an exterior perspective view of a cartridge system for extracting a collected sample according to some embodiments of the present invention.

FIG. 2 is a cross-sectional view of the cartridge system for extracting a collected sample of FIG. 1.

FIGS. 3 to 23 are cross-sectional views of stages of a collected sample extraction process of the cartridge system for extracting a collected sample of FIG. 1.

FIG. 24 is a flowchart illustrating a method for extracting a collected sample according to some embodiments of the present invention.

FIG. 25 is a flowchart illustrating step (a) of the method for extracting a collected sample of FIG. 24 in more detail.

FIG. 26 is a flowchart illustrating step (c) of the method for extracting a collected sample of FIG. 24 in more detail.

FIG. 27 is a flowchart illustrating step (f) of the method for extracting a collected sample of FIG. 24 in more detail.

### MODE FOR INVENTION

Hereinafter, exemplary embodiments of the present invention will be described in detail with reference to the accompanying drawings.

The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the thicknesses or sizes of layers are exaggerated for clarity and convenience of explanation.

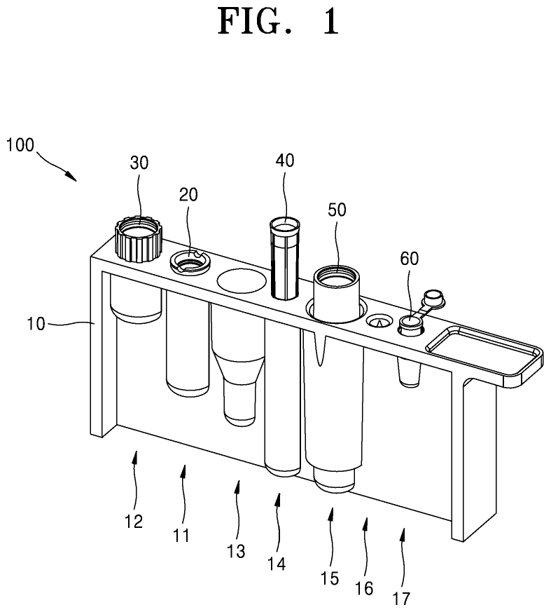

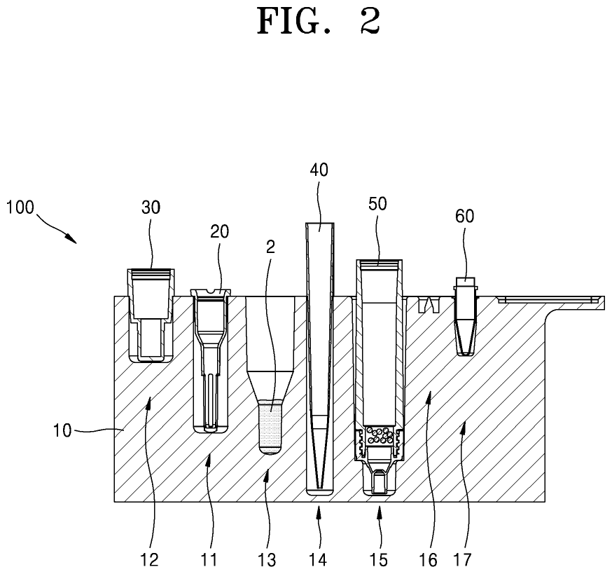

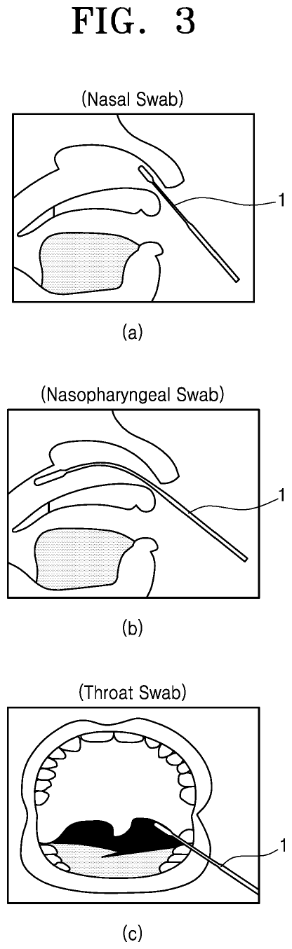

FIG. 1 is an exterior perspective view of a cartridge system 100 for extracting a collected sample according to some embodiments of the present invention and FIG. 2 is a cross-sectional view of the cartridge system 100 for extracting a collected sample of FIG. 1. In addition, FIGS. 3 to 23 are cross-sectional views of stages of a collected sample extraction process of the cartridge system for extracting a collected sample of FIG. 1.

First, as shown in FIGS. 1 and 2, the cartridge system 100 for extracting a collected sample according to some embodiments of the present invention broadly includes a cartridge body 10 and a dewatering tip-receiving unit 11, a spin cover-receiving unit 12, a buffer chamber unit 13, a dispensing tip-receiving unit 14, a filter tip-receiving unit 15, a cutting edge unit 16, and a collecting tube-receiving unit 17, which are all formed in the cartridge body 10.

For example, as shown in FIGS. 1 and 2, the cartridge body 10, which may be detachably mounted inside inspection equipment (not shown) installed at an inspection site or at the point of care, may be an integrated structure made of synthetic resin material or metal material with sufficient strength and durability to support the dewatering tip-receiving unit 11, the spin cover-receiving unit 12, the buffer chamber unit 13, the dispensing tip-receiving unit 14, the filter tip-receiving unit 15, the cutting edge unit 16, and the collecting tube-receiving unit 17.

However, the shape, type, material, design, and the like of the cartridge body 10 are not limited thereto, and they may be modified or changed as needed depending on the specifications of the equipment where the cartridge system is to be mounted, the inspection environment, or the required specifications.

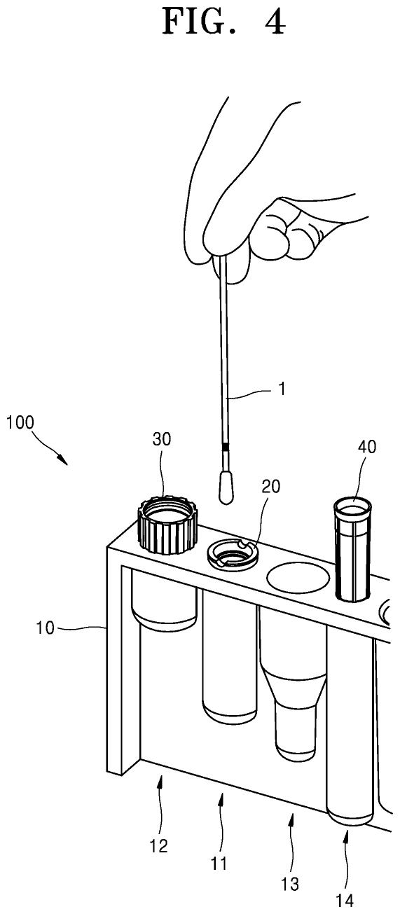

More specifically, as shown in FIGS. 1 and 2, the dewatering tip-receiving unit 11, formed in the cartridge body 10, may be a portion where a dewatering tip 20 is accommodated, allowing a collecting member 1 of FIG. 4 that has collected a sample to be accommodated.

The collecting member 1 may include various collection bodies capable of collecting a sample, and may include, for example, a cotton swab. Hereinafter, the description will focus on the case of a cotton swab as an example of the collecting member 1, but the technical idea of the present invention is not limited thereto.

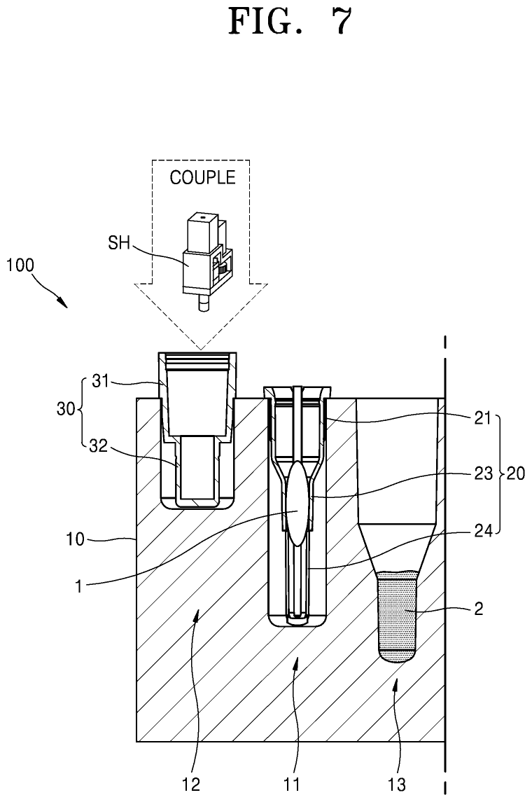

More specifically, as shown in FIGS. 1 and 2, the spin cover-receiving unit 12, formed in the cartridge body 10, may be a portion where a spin cover 30 is accommodated such that a spin head SH of a robot device in FIG. 7 can be equipped with the spin cover 30.

Further specifically, as shown in FIGS. 1 and 2, the buffer chamber unit 13 is formed in the cartridge body 10, serving as a portion where a buffer solution 2 is accommodated, such that the sample from the collecting member 1 can be discharged and received in the buffer solution 2 through dewatering by the rotation of the spin head SH of the robot device when the collecting member 1 is immersed into the buffer solution 2 while the spin head SH equipped with the spin cover 30 is coupled with the dewatering tip 20.

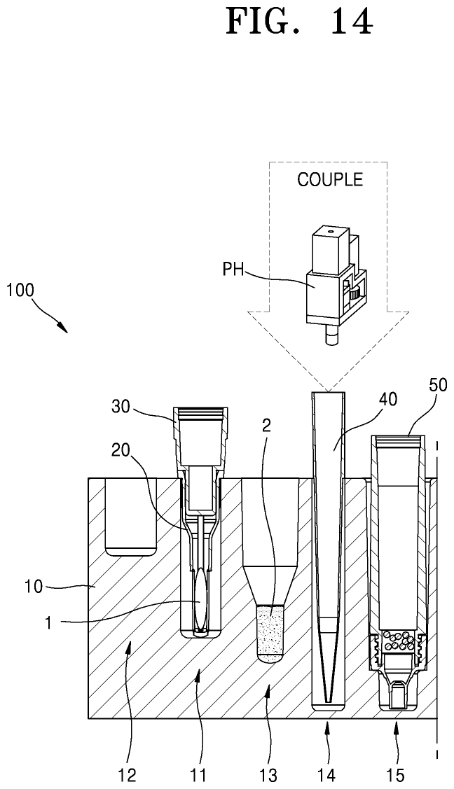

More specifically, as shown in FIGS. 1 and 2, the dispensing tip-receiving unit 14 is formed in the cartridge body 10, serving as a portion where a dispensing tip 40 is accommodated, such that a pump head PH of the robot device in FIG. 14 can be equipped with the dispensing tip 40 to aspirate the buffer solution 2 containing the sample.

More specifically, as shown in FIGS. 1 and 2, the filter tip-receiving unit 15 is formed in the cartridge body 10, serving as a portion where a filter tip 50 is accommodated such that when the dispensing tip 40 that has aspirated the buffer solution 2 containing the sample dispenses the buffer solution 2 to the filter tip 50, the spin head SH can be coupled with the filter tip 50 and rotates it, for example, repeatedly in both forward and reverse rotations, to stir the buffer solution 2.

More specifically, as shown in FIGS. 1 and 2, the cutting edge unit 16 is formed in the cartridge body 10, and may be a sharply shaped portion to facilitate the breaking or removal of the temporary sealing member 54.

Further specifically, as shown in FIGS. 1 and 2, the collecting tube-receiving unit 17, formed in the cartridge body 10, may be a portion in which a final solution collecting tube 60 is accommodated such that the pump head PH coupled with the filter tip 50 can inject the buffer solution 2 containing the sample into the final solution collecting tube 60. For example, after the temporary sealing member 54 is broken or removed, the buffer solution 2 containing the sample may be injected into the final solution collecting tube 60.

Here, as shown in FIGS. 1 and 2, in accordance with the order of the pretreatment processes for extracting the collected sample, the distal tip-receiving unit 11, the spin cover-receiving unit 12, the buffer chamber unit 13, the dispensing tip-receiving unit 14, the filter tip-receiving unit 15, the cutting edge unit 16, and the collecting tube-receiving unit 17 may be arranged in a line in this order, from the front end to the rear end of the upper surface of the cartridge body 10. However, this arrangement order is illustrative, and the technical idea of the present invention is not limited thereto.

Therefore, as shown in FIGS. 1 and 2, the movement distances of the spin head SH and the pump head PH of the robot device installed in the aforementioned inspection equipment may be minimized. In other words, while the spin head SH and the pump head PH intermittently move from the front end to the rear end of the cartridge body 10, a series of collected-sample extraction processes of extracting the collected sample from the collecting member 1 and dispersing the buffer solution 2 containing the sample into the final solution collecting tube 60 may be sufficiently performed sequentially within only a single cartridge system for extracting a collected sample according to some embodiments of the present invention.

Therefore, to apply a molecular diagnostic method, a series of pretreatment processes of extracting the sample collected from the collecting member 1 with the buffer solution E is automated and integrated in a cartridge format, so that the efficiency of sample extraction may be increased, the time and cost involved in sample extraction may be significantly reduced, and precise, uniform, and highly reliable sample pretreatment processes may be conducted regardless of the operator's skill level or working environment. Also, sample contamination or leakage during the process may be fundamentally prevented, and the application to an on-site rapid diagnostic kit is possible, enabling quick achievement of test results within minutes or hours on-site.

FIGS. 3 to 23 are cross-sectional views of stages of a collected sample extraction process of the cartridge system 100 for extracting a collected sample of FIG. 1.

As shown in FIGS. 3 to 23, a more detailed description of the extraction process of the cartridge system 100 for extracting a collected sample according to some embodiments of the present invention is provided. First, as shown in FIG. 3, to collect a sample using a swab as the collecting member 1 for collecting the sample from the human body, various methods such as nasal swab, nasopharyngeal swab, throat swab, etc., may be employed.

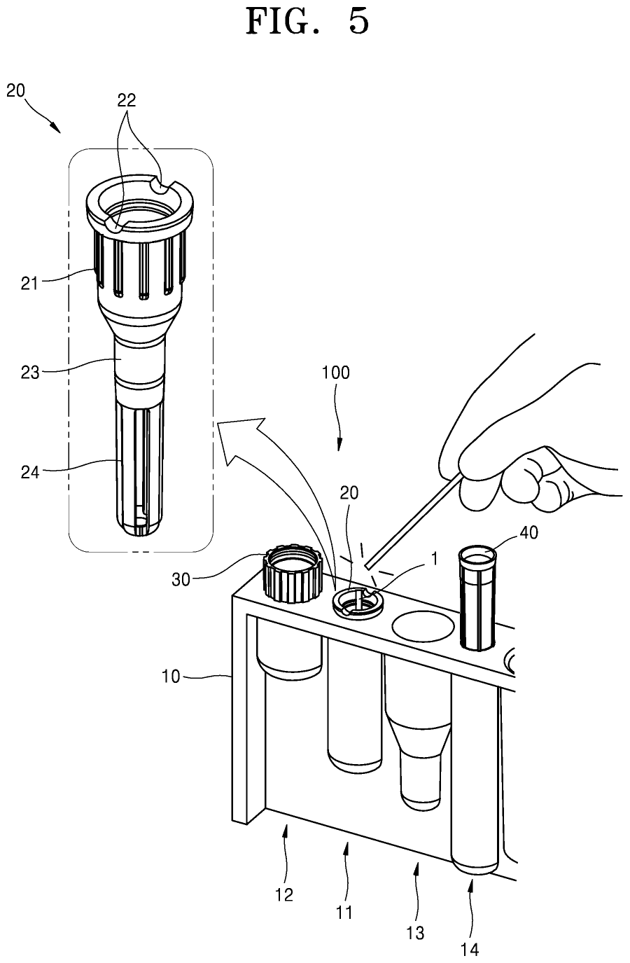

Subsequently, as shown in FIGS. 4 and 5, a portion of the collecting member 1 that has collected the sample may be inserted into a collecting member-receiving area of a dewatering tip body 21 of the dewatering tip 20 accommodated in the dewatering tip-receiving unit 11 of the cartridge body 10.

Subsequently, as shown in FIG. 5, a portion of the collecting member 1 may be bent and segmented so that the collecting member 1 may be temporarily fitted and fixed in a middle constricted portion 23.

Here, for example, as shown in FIG. 5, the dewatering tip 20 may include the dewatering tip body 21 in which the collected sample-receiving area is formed to accommodate a portion of the collecting member 1, a segmentation groove portion 22 formed at the entrance of the dewatering tip body 21 to allow bending and segmentation of a portion of the collecting member 1, the middle constricted portion 23 formed at the bottom of the dewatering tip body 21 to allow the collecting member 1 to be temporarily fitted and fixed in the middle, and a dewatering slot portion 24 formed at the bottom of the middle constricted portion 23 to allow the buffer solution 2, containing the sample, to be dewatered and extracted from the collecting member 1 by the centrifugal force when rotated using the spin head SH after the collecting member 1 is fully inserted.

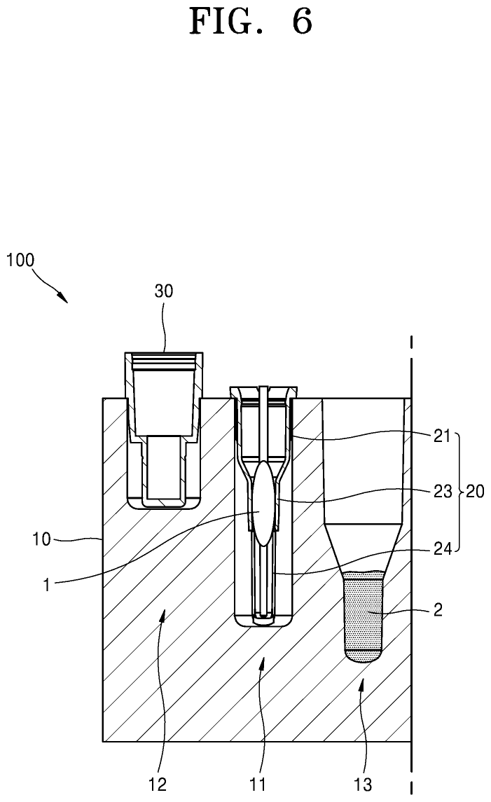

Therefore, as shown in FIG. 6, the collecting member 1 may be temporarily fitted and fixed in the middle constricted portion 23 in a state in which a portion of the collecting member 1 is segmented using the segmentation groove portion 22.

Subsequently, as shown in FIG. 7, the spin head SH of the robot device may be equipped with the spin cover 30 accommodated in the spin cover-receiving unit 12.

Here, for example, the spin cover 30 may include a spin cover body 31 with a head coupling portion formed to be coupled with the spin head SH and a pressing edge portion 32 that, when inserted into the entrance of the dewatering tip body 21 during coupling with the dewatering tip 20, pressurizes the collecting member 1 to enable the complete insertion of the collecting member 1, which is temporarily fixed in the middle constricted portion 23, into the dewatering slot portion 24.

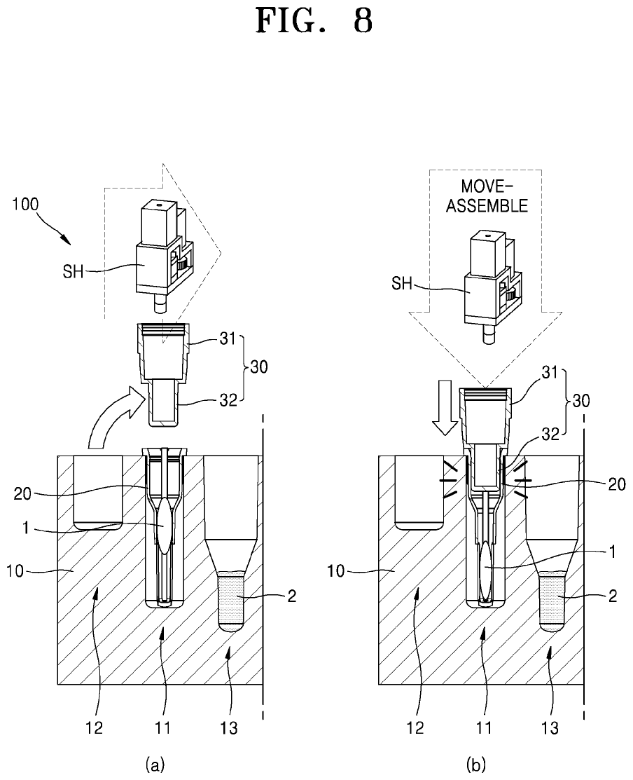

Subsequently, as shown in (a) of FIG. 8, the spin head SH is aligned above the dewatering tip 20. Then, as shown in (b) of FIG. 8, the collecting member 1 may be completely inserted into the dewatering slot portion 24 by applying pressure using the pressing edge portion 32 of the spin head SH.

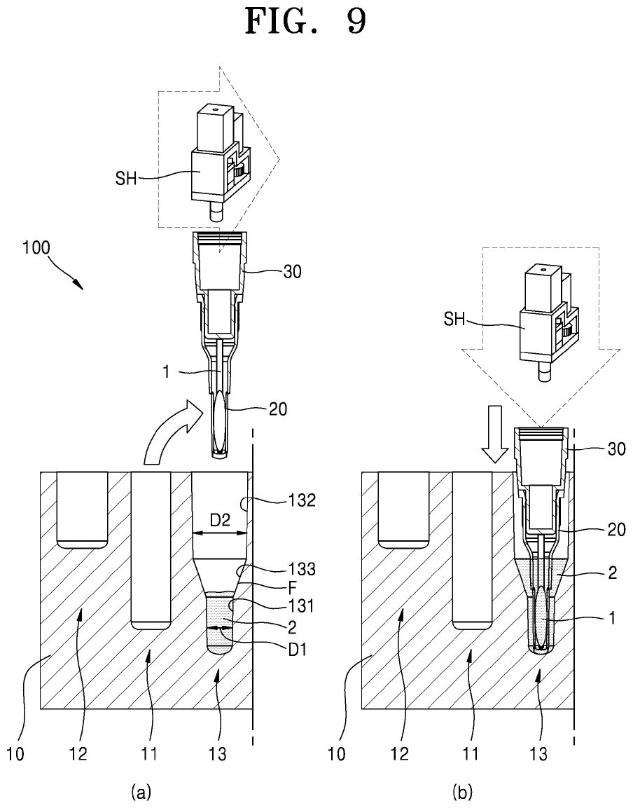

Next, as shown in (a) of FIG. 9, the spin head SH is aligned above the dewatering tip 20 and then moved to an upper part of the buffer chamber unit 13 that accommodates the buffer solution 2. Then, as shown in (b) of FIG. 9, the spin head SH descends, inserting the dewatering tip 20 into the buffer chamber unit 13 and, accordingly, the collecting member 1 may be sufficiently submerged below the level of the buffer solution 2 in the buffer chamber unit 13.

At this point, as shown in (a) of FIG. 9, the buffer chamber unit 13 may include a buffer solution-receiving portion 131 formed with a first diameter D1 to accommodate the buffer solution 2 so that the collecting member 1 can be sufficiently immersed below the level of the buffer solution 2. It may also include a dewatering portion 132 formed with a second diameter D2 larger than the first diameter D1 to allow the collecting member 1 to rise sufficiently above the level of the buffer solution 2 for rotation and dewatering. Additionally, it may include a guiding slope portion 133 having a guiding slope surface F continuously changing in diameter from the first diameter D1 to the second diameter D2 to guide the dewatered buffer solution 2 in the direction of the buffer solution-receiving portion 131.

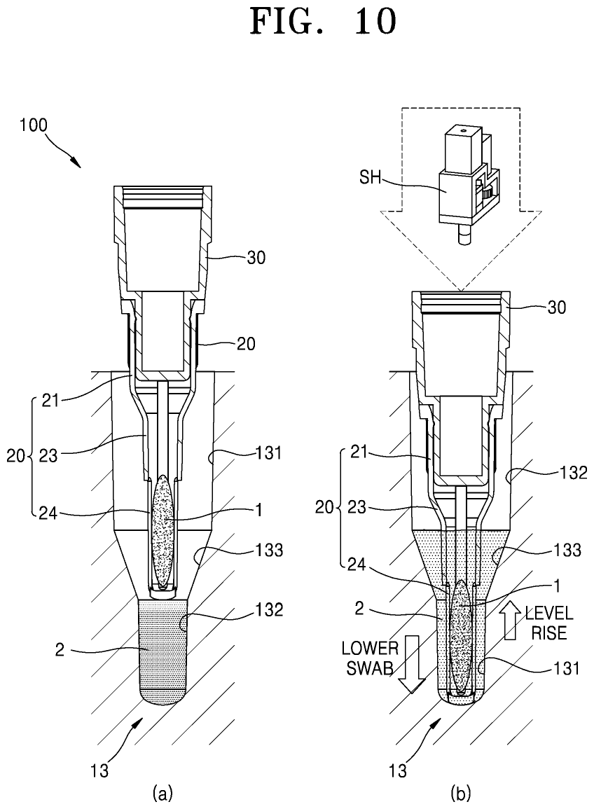

Subsequently, for example, with the spin head SH in the raised position as shown in (a) of FIG. 10, the series of processes in which the spin head SH descends to sufficiently immerse the collecting member 1 below the level of the buffer solution 2 in the buffer chamber unit 13 as shown in (b) of FIG. 10, may be performed once or repeated multiple times.

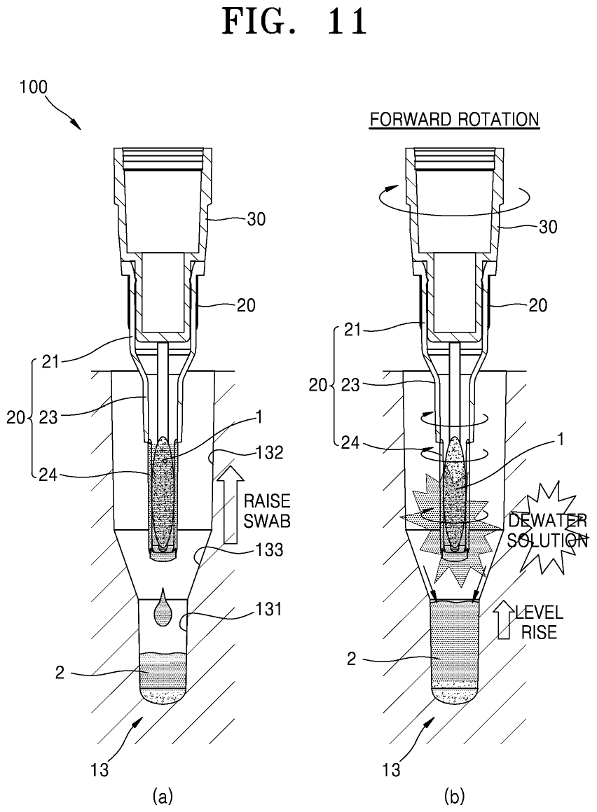

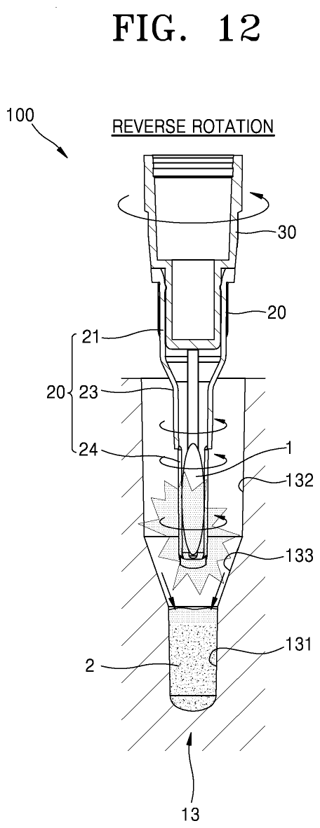

At this point, for example, as shown in (a) of FIG. 11, the collecting member 1 may be sufficiently raised above the level of the buffer solution 2 in the buffer chamber unit 13, and the buffer solution 2 may be adequately dewatered by repeatedly rotating the spin head SH in both forward (clockwise) and reverse (counterclockwise) directions, as shown in (b) of FIG. 11 and FIG. 12. Consequently, the sample collected on the collecting member 1 may be accommodated in the buffer solution 2.

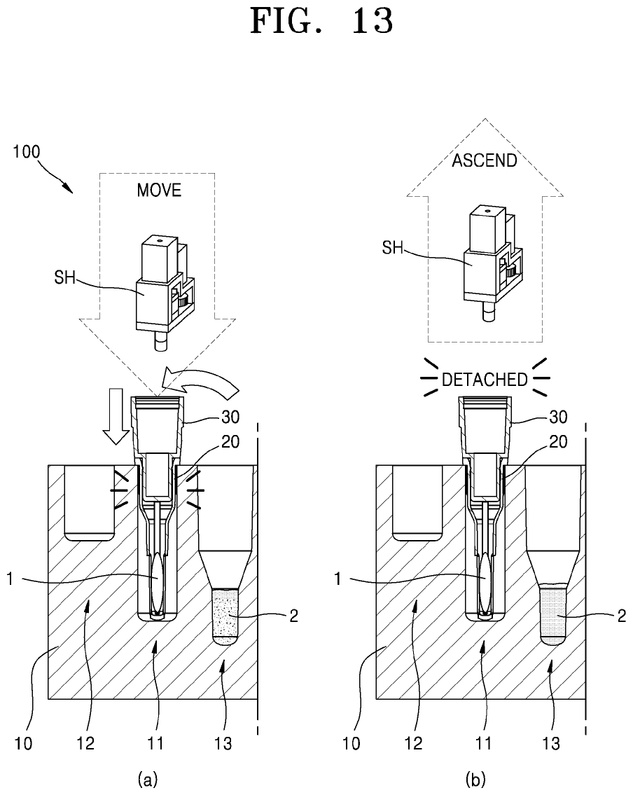

Then, for example, as shown in (a) of FIG. 13, the spin head SH of the robot device is moved from the buffer chamber unit 13 to the dewatering tip-receiving unit 11, allowing the dewatering tip 20 and the skin cover 30 to be temporarily stored in the dewatering tip-receiving unit 11 for subsequent disposal. Then, as shown in (b) of FIG. 13, the spin head SH may be lifted and detached from the spin cover 30 using a separate device such as a clamp or a finger arm.

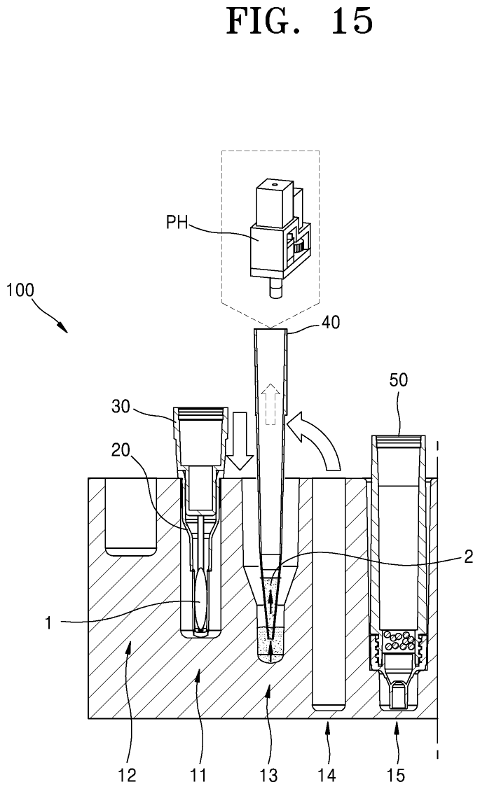

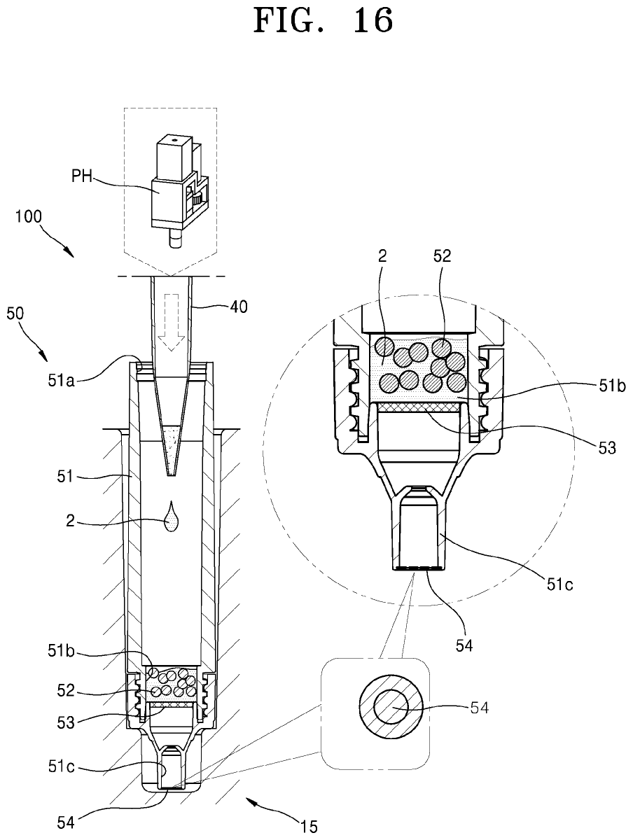

Next, for example, as shown in FIG. 14, the pump head PH of the robot device may be equipped with the dispensing tip 40, and then move the dispensing tip 40 to the buffer chamber unit 13 to aspirate the buffer solution 2 containing the sample, as shown in FIG. 15. Subsequently, as shown in FIG. 16, the pump head PH may move the dispensing tip 40 to the filter tip-receiving unit 15, and the dispensing tip 40 may dispense the buffer solution 2 containing the sample onto the filter tip 50.

Here, for example, as shown in FIG. 16, the filter tip 50 may include a filter tip body 51, which has an inlet portion 51a formed on the upper side thereof into which the front end of the dispensing tip 40 is inserted, an accommodating portion 51b in which the buffer solution 2 is accommodated, and an outlet portion 51c from which the buffer solution 2 is discharged, a plurality of beads 52 installed in the accommodating portion 51b to facilitate agitation of the buffer solution 2, a mesh filter 53 installed between the accommodating portion 51b and the outlet portion 51c, and a temporary sealing member 54 which temporarily seals the outlet portion 51c.

Accordingly, as shown in FIG. 16, even when the dispensing tip 40 dispenses the buffer solution 2 to the filter tip 50, the temporary sealing member 54 may prevent the buffer solution 2 from leaking downward from the outlet portion 51c and allow it to be accommodated in the accommodating portion 51b of the filter tip 50.

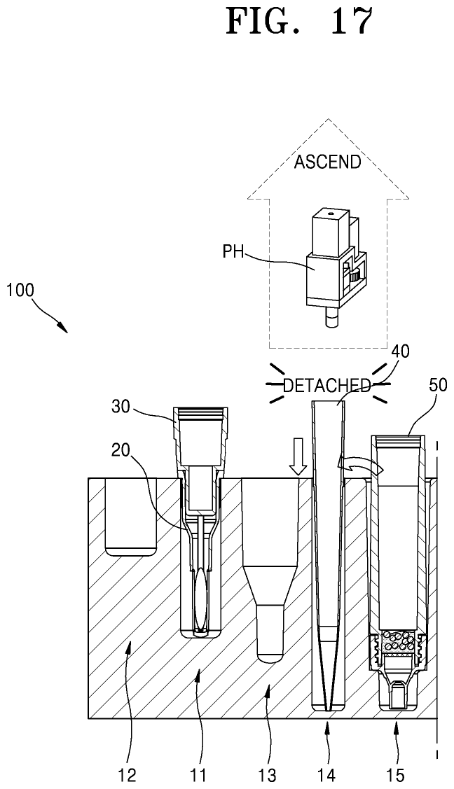

Then, for example, as shown in FIG. 17, the pump head PH of the robot device may move the dispensing tip 40 to the dispensing tip-receiving unit 14 to temporarily store the dispensing tip 40 for subsequent disposal.

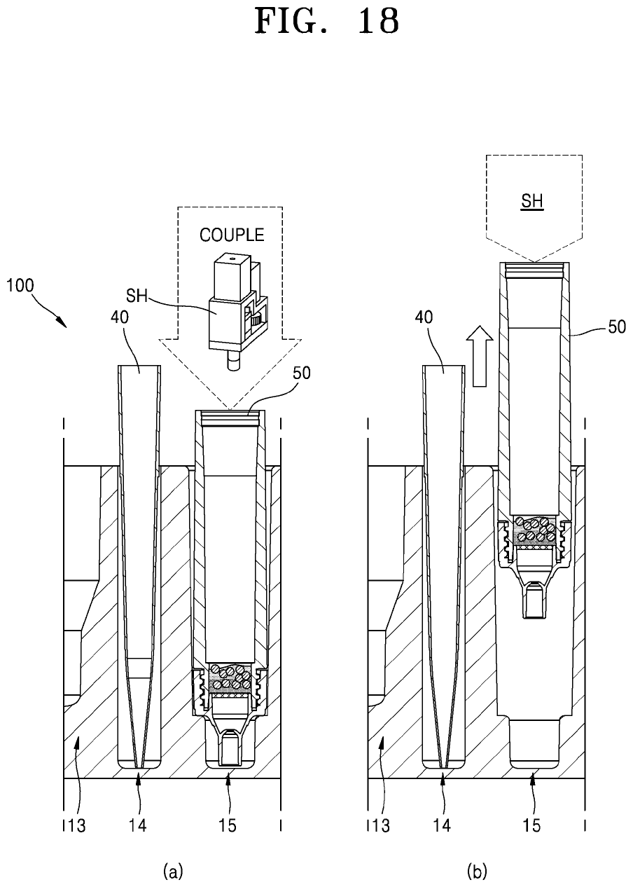

Next, for example, as shown in (a) of FIG. 18, the spin head SH of the robot device is coupled with the filter tip 50, and as shown in (b) of FIG. 18, the spin head SH may raise the filter tip 50 to be sufficiently spaced apart from the filter tip-receiving unit 15.

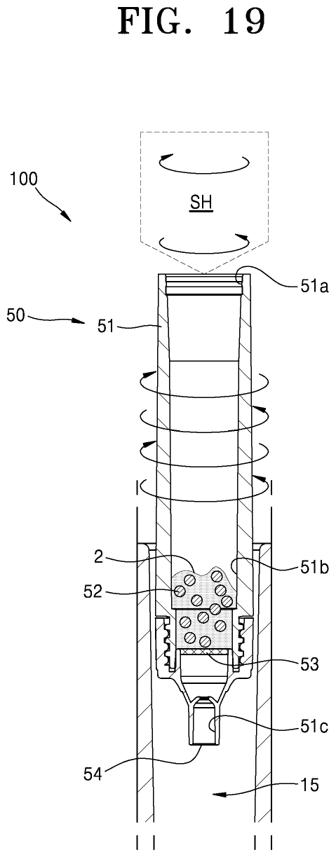

Then, for example, as shown in FIG. 19, the spin head SH may rotate the filter tip 50 in both forward (clockwise) and reverse (counterclockwise) directions, and while repeating this process, the buffer solution 2 may be thoroughly stirred using the beads 52.

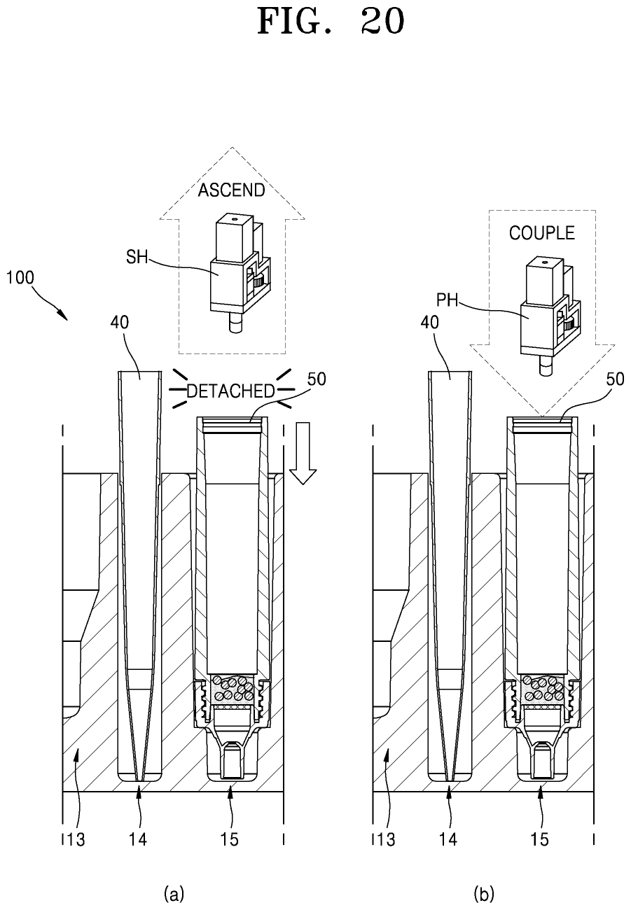

Subsequently, for example, as shown in (a) of FIG. 20, the spin head SH is raised and detached from the filter tip 50. Then, as shown in (b) of FIG. 20, the pump head PH may descend to be coupled with the filter tip 50.

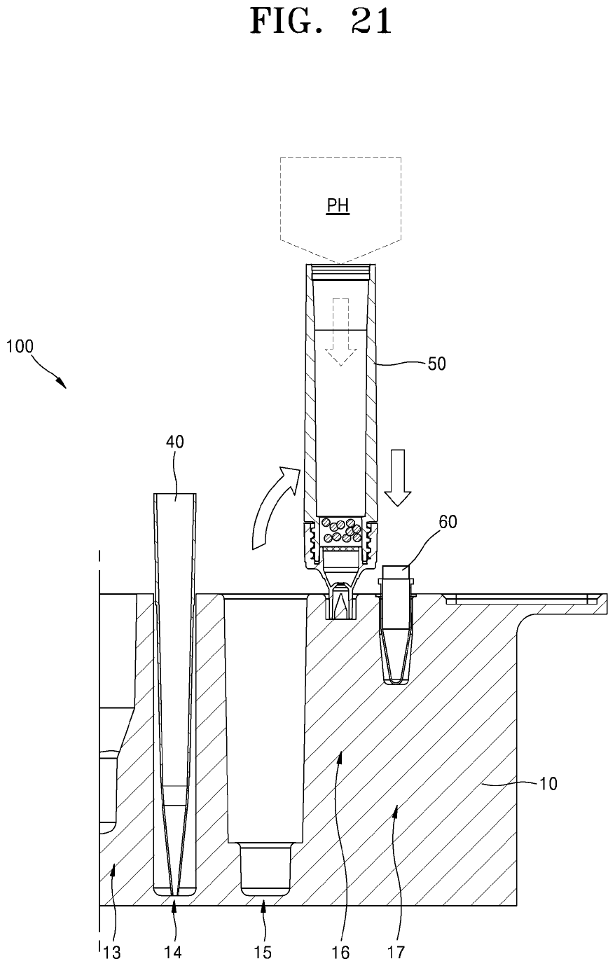

Next, for example, as shown in FIG. 21, the temporary sealing member 54 temporarily sealed to the outlet portion 51c of the filter tip 50 may be broken or removed using the cutting edge unit 16 sharply formed on the cartridge body 10. For example, the pump head PH may lift the filter tip 50 and discharge it from the filter tip-receiving unit 15. After moving to the upper side of the cutting edge unit 16, the pump head PH may lower the filter tip 50, pressing it against the cutting edge unit 16 to break or remove the temporary sealing member 54.

At this point, the suction pressure of the pump head PH may be adjusted or maintained to prevent the buffer solution 2 accommodated in the filter tip 50 from leaking downward.

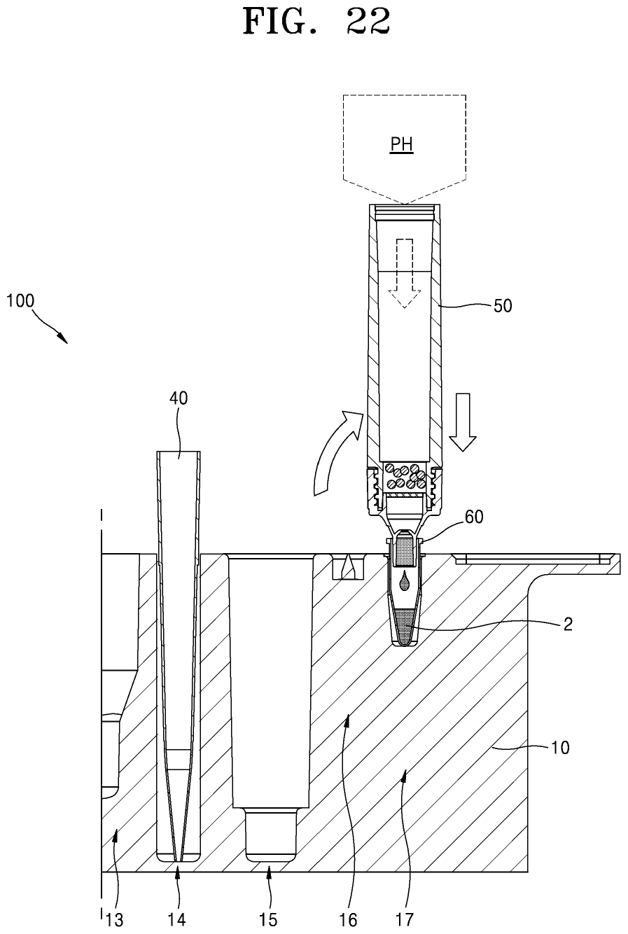

Subsequently, as shown in FIG. 22, the pump head PH may move the filter tip 50 to the collecting tube-receiving unit 17 and pressurize it to inject the buffer solution 2 into the final solution collecting tube 60.

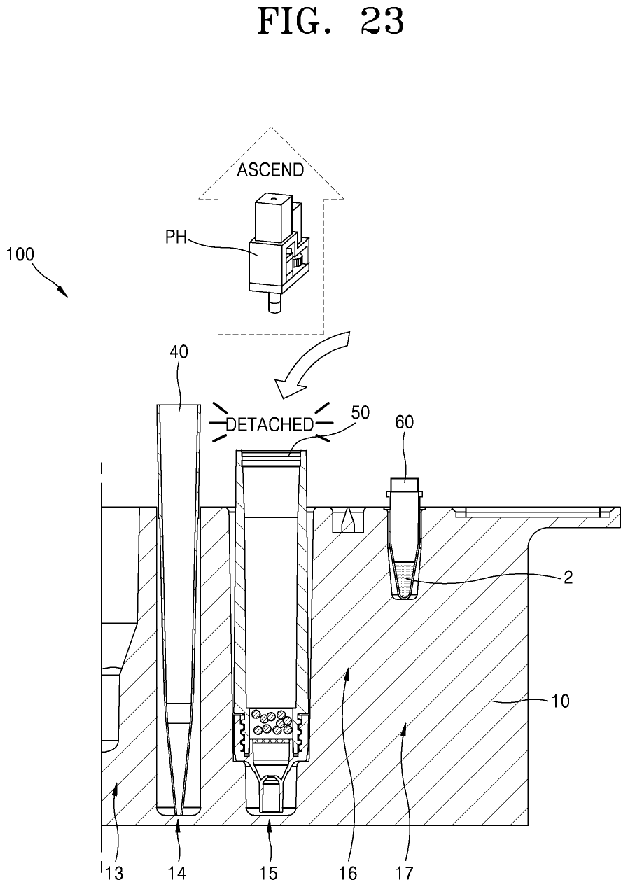

Then, as shown in FIG. 23, the pump head PH may move the filter tip 50 to the filter tip-receiving unit 15 to temporarily store it in the filter tip-receiving unit 15 for subsequent disposal.

Therefore, according to the present invention, a series of pretreatment processes of immersing, dewatering, stirring, and extracting the sample collected by the collecting member 1 in the buffer solution 2 may be automatically and rapidly performed within a single cartridge system 100 for extracting a collected sample. After completing all the pretreatment processes, all components may be disposed of or incinerated together, ensuring a highly hygienic process.

However, this series of sample collection and extraction processes is not necessarily limited to the drawings and modifications and changes can be made by those skilled in the art without departing from the technical idea of the present invention.

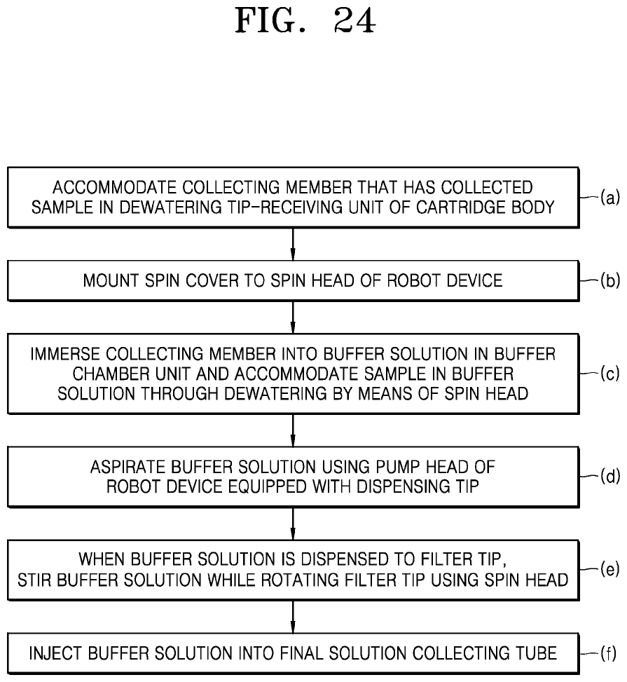

FIG. 24 is a flowchart illustrating a method for extracting a collected sample according to some embodiments of the present invention.

As shown in FIGS. 1 to 24, a method for extracting a collected sample according to some embodiments of the present invention may include the steps of: (a) accommodating the collecting member 1 that has collected a sample in the dewatering tip-receiving unit 11 of the cartridge body 10; (b) mounting the spin cover 30 to the spin head SH of the robot device; (c) immersing the collecting member 1 into the buffer solution 2 in the buffer chamber unit 13 by coupling the dewatering tip 20 with the spin head SH of the robot device with the spin cover 30 mounted thereto, followed by accommodating the sample in the buffer solution 2 through dewatering by the rotation of the spin head SH; (d) aspirating the buffer solution 2 containing the sample using a pump head PH of the robot device equipped with a dispensing tip 40; (e) when the dispensing tip 40 dispenses the buffer solution 2 containing the sample to a filter tip 50, stirring the buffer solution 2 while rotating the filter tip 60 repeatedly, for example, in forward and reverse direction, using the spin head SH coupled with the filter tip 50; and (f) injecting the buffer solution 2 containing the sample into a final solution collecting tube 60.

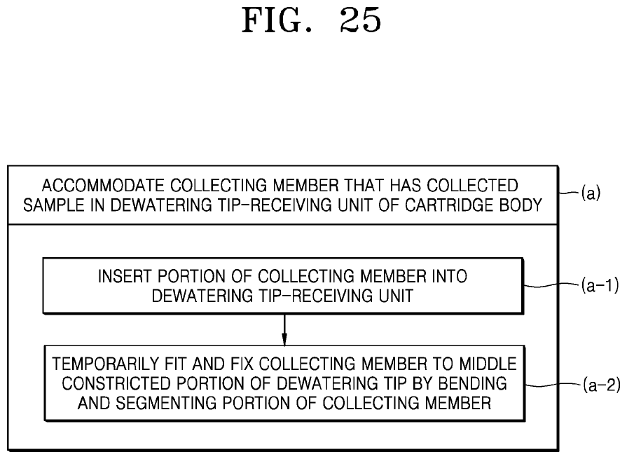

FIG. 25 is a flowchart illustrating step (a) of the method for extracting a collected sample of FIG. 24 in more detail.

As shown in FIGS. 1 to 25, the step (a) may include (a-1) inserting a portion of the collecting member 1 into the dewatering tip 20 accommodated in the dewatering tip-receiving unit 11 and (a-2) temporarily fitting and fixing the collecting member 1 to the middle constricted portion 23 of the dewatering tip 20 by bending and segmenting a portion of the collecting member 1.

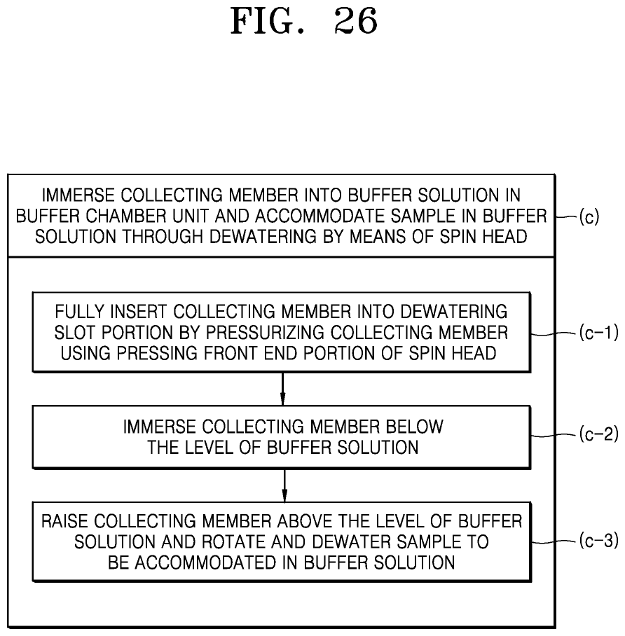

FIG. 26 is a flowchart illustrating step (c) of the method for extracting a collected sample of FIG. 24 in more detail.

As shown in FIGS. 1 to 26, the step (c) may include: (c-1) fully inserting the collecting member 1 into the dewatering slot portion 24 of the dewatering tip 20 by pressurizing the collecting member 1 using the pressing front end portion 32 of the spin head SH; (c-2) immersing the collecting member 1 below the level of the buffer solution 2 in the buffer chamber unit 13; and (c-3) raising the collecting member 1 above the level of the buffer solution 2 in the buffer chamber unit 13 and rotating and dewatering the sample to be accommodated in the buffer solution 2.

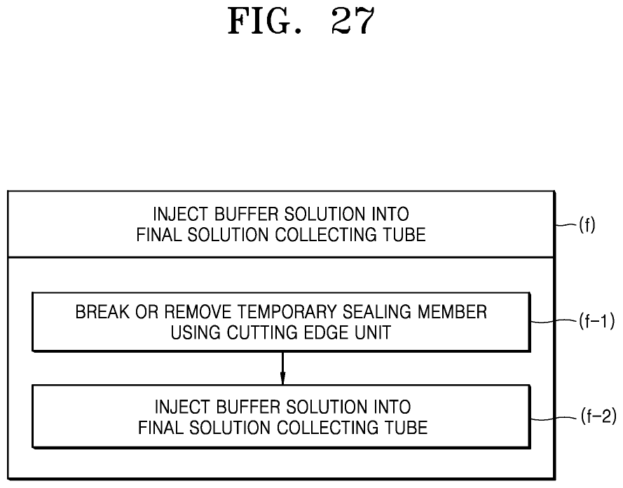

FIG. 27 is a flowchart illustrating step (f) of the method for extracting a collected sample of FIG. 24 in more detail.

As shown in FIGS. 1 to 27, the step (f) may include: (f-1) breaking or removing the temporary sealing member 54 temporarily sealed to the outlet portion 51c of the filter tip 50 using the cutting edge unit 16; and (f-2) injecting the buffer solution 2 into the final solution collecting tube 60 when the pump head PH is coupled with the filter tip 50 and the temporary sealing member 54 is broken or removed.

While the present invention has been particularly shown and described with reference to embodiments thereof, it will be understood by those of ordinary skill in the art that various changes in form and details may be made therein without departing from the spirit and scope of the present invention as defined by the following claims. Therefore, the scope of the present invention should be defined only by the appended claims.

1. A cartridge system for extracting a collected sample, comprising:
a cartridge body;
a dewatering tip-receiving unit formed in the cartridge body and configured to accommodate a dewatering tip such that a collecting member that has collected a sample is accommodated;
a spin cover-receiving unit formed in the cartridge body and configured to accommodate a spin cover of a robot device such that the spin head can be equipped with the spin cover;
a buffer chamber unit formed in the cartridge body and configured to accommodate a buffer solution such that a sample from the collecting member can be discharged and received in the buffer solution through dewatering by the rotation of the spin head of the robot device when the collecting member is immersed into the buffer solution while the spin head equipped with the spin cover is coupled with the dewatering tip; and
a dispensing tip-receiving unit formed in the cartridge body and configured to accommodate a dispensing tip such that a pump head of the robot device can be equipped with the dispensing tip to aspirate the buffer solution containing the sample.

2. The cartridge system of claim 1, wherein the dewatering tip includes
a dewatering tip body in which a collected sample-receiving area is formed to accommodate a portion of the collecting member;
a segmentation groove portion formed at the entrance of the dewatering tip body to allow bending and segmentation of a portion of the collecting member;
a middle constricted portion formed at the bottom of the dewatering tip body to allow the collecting member to be temporarily fitted and fixed in the middle; and
a dewatering slot portion formed at the bottom of the middle constricted portion to allow the buffer solution, containing the sample, to be dewatered and extracted from the collecting member by the centrifugal force when rotated using the spin head after the collecting member is fully inserted.

3. The cartridge system of claim 2, wherein the spin cover includes
a spin cover body with a head coupling portion formed to be coupled with the spin head; and
a pressing edge portion that, when inserted into the entrance of the dewatering tip body during coupling with the dewatering tip, pressurizes the collecting member to enable the complete insertion of the collecting member, which is temporarily fixed in the middle constricted portion, into the dewatering slot portion.

4. The cartridge system of claim 1, wherein the buffer chamber unit includes
a buffer solution-receiving portion formed with a first diameter to accommodate the buffer solution so that the collecting member can be sufficiently immersed below the level of the buffer solution;
a dewatering portion formed with a second diameter larger than the first diameter to allow the collecting member to rise sufficiently above the level of the buffer solution for rotation and dewatering; and
a guiding slope portion having a guiding slope surface continuously changing in diameter from the first diameter to the second diameter to guide the dewatered buffer solution in the direction of the buffer solution-receiving portion.

5. The cartridge system of claim 1, further comprising a filter tip-receiving unit formed in the cartridge body and configured to accommodate a filter tip such that when the dispensing tip that has aspirated the buffer solution containing the sample dispenses the buffer solution to the filter tip, the spin head can be coupled with the filter tip and rotate it to stir the buffer solution.

6. The cartridge system of claim 5, wherein the filter tip includes
a filter tip body, which has an inlet portion formed on an upper side thereof into which a front end of the dispensing tip is inserted, an accommodating portion in which the buffer solution is accommodated, and an outlet portion from which the buffer solution is discharged;
a plurality of beads installed in the accommodating portion to facilitate agitation of the buffer solution; and
a mesh filter installed between the accommodating portion and the outlet portion.

7. The cartridge system of claim 6, wherein the filter tip further includes a temporary sealing member that temporarily seals the outlet portion.

8. The cartridge system of 7, further comprising a cutting edge unit formed in the cartridge body and sharply shaped to facilitate breaking or removal of the temporary sealing member.

9. The cartridge system of claim 1, further comprising a collecting tube-receiving unit formed in the cartridge body and configured to accommodate a final solution collecting tube such that the pump head coupled with the filter tip can inject the buffer solution containing the sample into the final solution collecting tube.

10. A method for extracting a collected sample, comprising the steps of:
(a) accommodating a collecting member that has collected a sample in a dewatering tip-receiving unit of a cartridge body;
(b) mounting a spin cover to a spin head of a robot device; and
(c) immersing the collecting member into a buffer solution in a buffer chamber unit by coupling a dewatering tip with the spin head of the robot device with the spin cover mounted thereto, followed by accommodating the sample in the buffer solution within the buffer chamber unit through dewatering by the rotation of the spin head.

11. The method of claim 10, wherein the step (a) comprises:
(a-1) inserting a portion of the collecting member into the dewatering tip accommodated in the dewatering tip-receiving unit; and
(a-2) temporarily fit and fix the collecting member to a middle constricted portion of the dewatering tip by bending and segmenting a portion of the collecting member.

12. The method of claim 11, wherein the step (c) comprises:
(c-1) fully inserting the collecting member into a dewatering slot portion of the dewatering tip by pressurizing the collecting member using a pressing front end portion of the spin head;
(c-2) immersing the collecting member below the level of the buffer solution in the buffer chamber unit; and
(c-3) raising the collecting member above the level of the buffer solution in the buffer chamber unit and rotating and dewatering the sample to be accommodated in the buffer solution.

13. The method of claim 10, further comprising the steps of:
(d) aspirating the buffer solution containing the sample using a pump head of the robot device equipped with a dispensing tip;
(e) when the dispensing tip dispenses the buffer solution containing the sample to a filter tip, stirring the buffer solution while rotating the filter tip using the spin head coupled with the filter tip; and
(f) injecting the buffer solution containing the sample into a final solution collecting tube.

14. The method of claim 13, wherein the step (f) comprises:
(f-1) breaking or removing a temporary sealing member temporarily sealed to an outlet portion of the filter tip using a cutting edge unit; and
(f-2) injecting the buffer solution into the final solution collecting tube when the pump head is coupled with the filter tip and the temporary sealing member is broken or removed.
